(19) United States
(12) Patent Application Publication
(10) Pub. No.: US 2013/0312801 A1
(43) Pub. Date: Nov. 28, 2013

(54) Hybrid Photovoltaic Devices And Applications Thereof

(71) Applicant: David L. Carroll, Winston Salem, NC (US)

(72) Inventor: David L. Carroll, Winston Salem, NC (US)

(73) Assignee: WAKE FOREST UNIVERSITY, Winston Salem, NC (US)

(21) Appl. No.: 13/880,310

(22) PCT Filed: Oct. 18, 2011
(86) PCT No.: PCT/US2011/056727

§ 371 Date: Aug. 6, 2013

Related U.S. Application Data
(60) Provisional application No. 61/394,306, filed on Oct. 18, 2010.

(51) Int. Cl. H01L 31/04

(52) U.S. Cl. CPC H02S 10/00
USPC 136/201; 136/206; 438/54

(57) ABSTRACT

In one aspect, photovoltaic apparatus comprising electrical and thermal production capabilities are described herein. In some embodiments, an apparatus described herein comprises a conduit core comprising at least one radiation transmissive surface, a fluid disposed in the conduit core and a photoactive assembly at least partially surrounding the conduit core, the photoactive assembly comprising a radiation transmissive first electrode, at least one photosensitive layer electrically connected to the first electrode, and a second electrode electrically connected to the photosensitive layer.

### RELATED APPLICATION DATA

This application claims priority under 35 U.S.C. §119(e) from U.S. Provisional Patent Application Ser. No. 61/394,306, filed on Oct. 18, 2010, the entirety of which is hereby incorporated by reference.

### FIELD

The present invention relates to photovoltaic devices and, in particular, to hybrid photovoltaic devices comprising electrical and thermal energy production capabilities.

### BACKGROUND

Photovoltaic devices convert electromagnetic radiation into electricity by producing a photo-generated current when connected across a load and exposed to light. The electrical power generated by photovoltaic cells can be used in many applications including lighting, heating, battery charging, and powering devices requiring electrical energy.

When irradiated under an infinite load, a photovoltaic device produces its maximum possible voltage, the open circuit voltage or V_{oc}. When irradiated with its electrical contacts shorted, a photovoltaic device produces its maximum current, I short circuit or I_{sc}. Under operating conditions, a photovoltaic device is connected to a finite load, and the electrical power output is equal to the product of the current and voltage. The maximum power generated by a photovoltaic device cannot exceed the product of V_{oc} and I_{sc}. When the load value is optimized for maximum power generation, the current and voltage have the values Iₘₐₓ and Vₘₐₓ, respectively.

A key characteristic in evaluating a photovoltaic cell's performance is the fill factor, ff. The fill factor is the ratio of the photovoltaic cell's actual power to its power if both current and voltage were at their maxima. The fill factor of a photovoltaic cell is provided according to equation (1).

ff=(IₘₐₓVₘₐₓ)/(I_{sc}V_{oc}) (1)

The fill factor of a photovoltaic is always less than 1, as I_{sc} and V_{oc}, are never obtained simultaneously under operating conditions. Nevertheless, as the fill factor approaches a value of 1, a device demonstrates less internal resistance and, therefore, delivers a greater percentage of electrical power to the load under optimal conditions.

Photovoltaic devices may additionally be characterized by their efficiency of converting electromagnetic energy into electrical energy. The conversion efficiency, ηₚ, of a photovoltaic device is provided according to equation (2), where P_{inc} is the power of the light incident on the photovoltaic.

ηₚ=ff*(I_{sc}V_{oc})/P_{inc} (2)

Devices utilizing crystalline or amorphous silicon dominate commercial applications, and some have achieved efficiencies of 23% or greater. However, efficient crystalline-based devices, especially of large surface area, are difficult and expensive to produce due to the problems in fabricating large crystals free from crystalline defects that promote exciton recombination. Commercially available amorphous silicon photovoltaic cells demonstrate efficiencies ranging from about 4 to 12%.

Constructing organic photovoltaic devices having efficiencies comparable to inorganic devices poses a technical challenge. Some organic photovoltaic devices demonstrate efficiencies on the order of 1% or less. The low efficiencies displayed in organic photovoltaic devices results from a severe length scale mismatch between exciton diffusion length (L_{D}) and organic layer thickness. In order to have efficient absorption of visible electromagnetic radiation, an organic film must have a thickness of about 500 nm. This thickness greatly exceeds exciton diffusion length which is typically about 50 nm, often resulting in exciton recombination.

Furthermore, a significant amount of the solar spectrum is not collected by current photovoltaic devices. Infrared radiation beyond 1150 nm, for example, is often converted to thermal energy within photovoltaic devices as opposed to electron-hole pairs. The generation of thermal energy within photosensitive regions of a photovoltaic device can produce negative consequences such as a reduction in V_{oc} and permanent structural damage to the photovoltaic cell.

### SUMMARY

In view of the foregoing, in one aspect, photovoltaic apparatus comprising electrical and thermal production capabilities are described herein. In some embodiments, an apparatus described herein comprises a conduit core comprising at least one radiation transmissive surface, a fluid disposed in the conduit core and a photoactive assembly at least partially surrounding the conduit core, the photoactive assembly comprising a radiation transmissive first electrode, at least one photosensitive layer electrically connected to the first electrode, and a second electrode electrically connected to the photosensitive layer.

In another aspect, a photovoltaic apparatus described herein comprises a plurality of photovoltaic cells, wherein at least one of the photovoltaic cells comprises a conduit core comprising at least one radiation transmissive surface, a fluid disposed in the conduit core and a photoactive assembly at least partially surrounding the conduit core, the photoactive assembly comprising a radiation transmissive first electrode, at least one photosensitive layer electrically connected to the first electrode, and a second electrode electrically connected to the photosensitive layer.

In at least partially surrounding the conduit core, a photoactive assembly of apparatus described herein, in some embodiments, is coupled to the conduit core. In some embodiments, for example, the photoactive assembly is disposed on a surface of the conduit core. Additionally, in some embodiments, a photosensitive layer of a photoactive assembly described herein comprises a photosensitive organic composition. In some embodiments, the photosensitive layer comprises a photosensitive inorganic composition. The photoactive assembly, in some embodiments, comprises a plurality of photosensitive layers. In some embodiments, photosensitive layers comprise a photosensitive organic composition, a photosensitive inorganic composition or combinations thereof. The second electrode of a photoactive assembly, in some embodiments, is non-radiation transmissive.

Moreover, in some embodiments, a fluid disposed in the conduit core is operable to absorb radiation having one or more wavelengths falling in the infrared region of the electromagnetic spectrum. In some embodiments, a fluid disposed in the conduit core is radiation transmissive.

Additionally, in some embodiments, a photovoltaic apparatus described herein is coupled to a heat exchanger or other apparatus operable to capture thermal energy generated in the fluid disposed in the conduit core.

In another aspect, methods of making a photovoltaic apparatus are described herein. In some embodiments, a method of making a photovoltaic apparatus comprises providing a conduit core comprising at least one radiation transmissive surface, disposing a fluid in the conduit core and at least partially surrounding the conduit with a photoactive assembly, the photoactive assembly comprising a radiation transmissive first electrode, at least one photosensitive layer electrically connected to the first electrode, and a second electrode electrically connected to the photosensitive layer. In some embodiments, the photoactive assembly is fabricated on the conduit core. In some embodiments, the photoactive assembly is fabricated independently of the conduit core and subsequently coupled to the conduit core.

In another aspect, methods of converting electromagnetic energy into electrical energy are described herein. In some embodiments, a method of converting electromagnetic energy into electrical energy comprises receiving radiation at a side or circumferential area of a photovoltaic apparatus, the photovoltaic apparatus comprising a conduit core comprising at least one radiation transmissive surface, a fluid disposed in the conduit core, and a photoactive assembly at least partially surrounding the conduit core, the photoactive assembly comprising a radiation transmissive first electrode, at least one photosensitive layer electrically connected to the first electrode, and a second electrode electrically connected to the photosensitive layer. In some embodiments, once the radiation is received at one or more points along the side or circumferential area of the photovoltaic apparatus, the radiation is transmitted into the at least one photosensitive layer of the photoactive assembly to generate excitons in the photosensitive layer. The generated holes and electrons, in some embodiments, are subsequently separated and the electrons removed into an external circuit in communication with the photovoltaic apparatus.

In some embodiments of methods of converting electromagnetic radiation into electrical energy, the path of at least a portion of the received electromagnetic radiation is altered by the fluid in the conduit core of the photovoltaic apparatus. In some embodiments, for example, at least a portion of the received radiation is refracted by the fluid in the conduit core. In some embodiments, at least a portion of the received radiation is focused or concentrated by the fluid in the conduit core onto the photosensitive layer of the photoactive assembly. In some embodiments, the path altered radiation is transmitted into the at least one photosensitive layer of the photoactive assembly for the generation of excitons. Focusing or concentrating at least a portion of the received radiation, in some embodiments, can increase the total intensity of radiation or the intensity of radiation per area transmitted into the at least one photosensitive layer.

In some embodiments, the fluid in the conduit core can serve to direct received electromagnetic radiation to the photoactive assembly coupled to the conduit core, thereby allowing greater amounts of electromagnetic radiation to reach the photoactive assembly. Moreover, directing electromagnetic energy to the photoactive assembly with the fluid disposed in the conduit core, in some embodiments, permits the use of a photoactive assembly covering less surface area on the conduit core, thereby reducing production cost of the photovoltaic apparatus.

In some embodiments, a method of converting electromagnetic radiation into electrical energy further comprises absorbing at least a portion of the received radiation with the fluid in the conduit core. In some embodiments, absorption of radiation by the fluid generates thermal energy. In one embodiment, for example, the fluid in the conduit core absorbs radiation having one or more wavelengths in the infrared region of the electromagnetic spectrum, the absorption of the radiation generating thermal energy. In some embodiments, the fluid is flowed through a heat exchanger or other apparatus operable able to capture thermal energy generated in the fluid. In some embodiments, the fluid is brought into thermal contact with one or more thermoelectric apparatus for collection of the heat energy. Additionally, in some embodiments, the heat exchanged fluid is returned to the conduit core for further generation and collection of thermal energy.

These and other embodiments of the present invention are described in greater detail in the detailed description which follows.

### BRIEF DESCRIPTION OF THE DRAWINGS

FIG. 1 illustrates a cut away view of an apparatus according to one embodiment described herein.

FIG. 2 illustrates a cross-sectional view of an apparatus according to one embodiment described herein.

FIG. 3 illustrates a photovoltaic apparatus according to one embodiment described herein.

FIG. 4 illustrates a photovoltaic apparatus in conjunction with a heat exchanger according to one embodiment described herein.

FIG. 5 illustrates altering the path of at least a portion of electromagnetic radiation received by a photovoltaic apparatus according to one embodiment described herein.

FIG. 6 illustrates the current density versus illumination angle for a photovoltaic apparatus according to one embodiment described herein.

FIG. 7 illustrates radiation absorption characteristics of a photovoltaic apparatus according to one embodiment described herein.

FIG. 8 illustrates the current density versus voltage for a photovoltaic apparatus according to one embodiment described herein.

FIG. 9 illustrates the external quantum efficiency (EQE) versus illumination wavelength for a photovoltaic apparatus according to one embodiment described herein.

FIG. 10 illustrates the light distribution characteristics of a conduit core according to one embodiment described herein.

FIG. 11 illustrates the thermal properties of a photovoltaic apparatus according to one embodiment described herein.

FIG. 12 illustrates the thermal properties of a photovoltaic apparatus according to one embodiment described herein.

### DETAILED DESCRIPTION

In one aspect, photovoltaic apparatus comprising electrical and thermal production capabilities are described herein. In some embodiments, an apparatus described herein comprises a conduit core comprising at least one radiation transmissive surface, a fluid disposed in the conduit core and a photoactive assembly at least partially surrounding the conduit core, the photoactive assembly comprising a radiation transmissive first electrode, at least one photosensitive layer electrically connected to the first electrode, and a second electrode electrically connected to the photosensitive layer.

Radiation transmissive, as used herein, refers to the ability to at least partially pass radiation in the visible region of the electromagnetic spectrum. In some embodiments, radiation transmissive materials can pass visible electromagnetic radiation with minimal absorbance or other interference. Moreover, electrodes, as used herein, refer to layers that provide a medium for delivering photo-generated current to an external circuit or providing bias voltage to an apparatus described herein. An electrode provides the interface between photoactive regions of a photovoltaic apparatus and a wire, lead, trace, or other means for transporting the charge carriers to or from the external circuit.

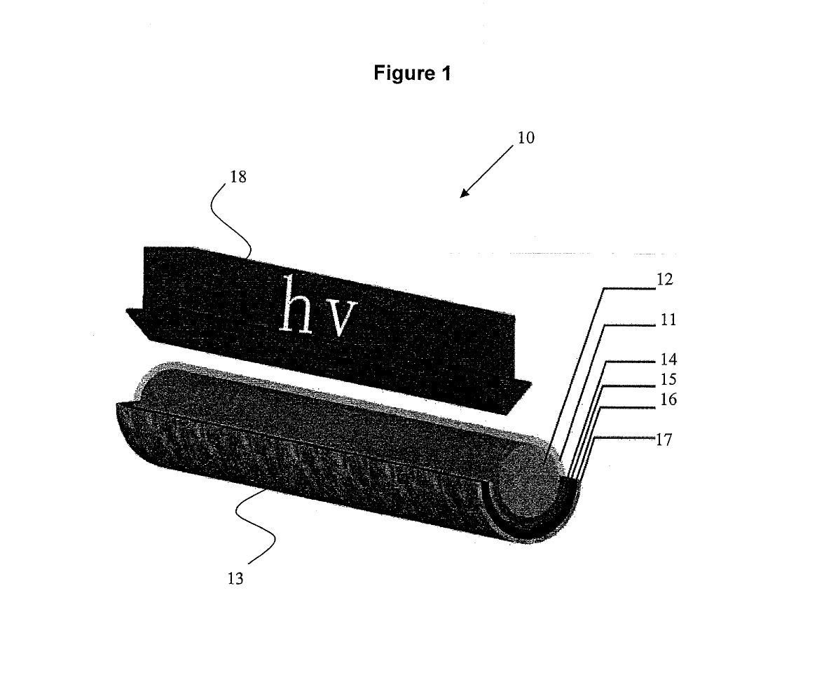

FIG. 1 illustrates a cut away view of a photovoltaic apparatus according to one embodiment described herein. The apparatus (10) illustrated in FIG. 1 comprises a conduit core (11) and a fluid (12) disposed in the conduit core (11). A photoactive assembly (13) is coupled to and at least partially surrounds the conduit core (11). In the embodiment of FIG. 1, the individual components of the photoactive assembly (13) surround about 50 percent of the exterior of the conduit core (11). As described herein, the photoactive assembly (13), in some embodiments, comprises a radiation transmissive first electrode (14), at least one photosensitive layer (16) electrically connected to the first electrode (14), and a second electrode (17) electrically connected to the photosensitive layer (16). An exciton blocking layer (15) described further herein is disposed between the radiation transmissive first electrode (14) and the photosensitive layer (16). In at least partially surrounding the conduit core (11), the photoactive assembly (13) has a curvature matching or substantially matching the curvature or the outer surface of the conduit core (11).

The apparatus (10) of FIG. 1 is operable to receive electromagnetic radiation (18) at one or more points at a side of the conduit core (11) or along a circumferential area of the conduit core (11). This is in opposition to receiving electromagnetic radiation along the longitudinal axis of the conduit core (11).

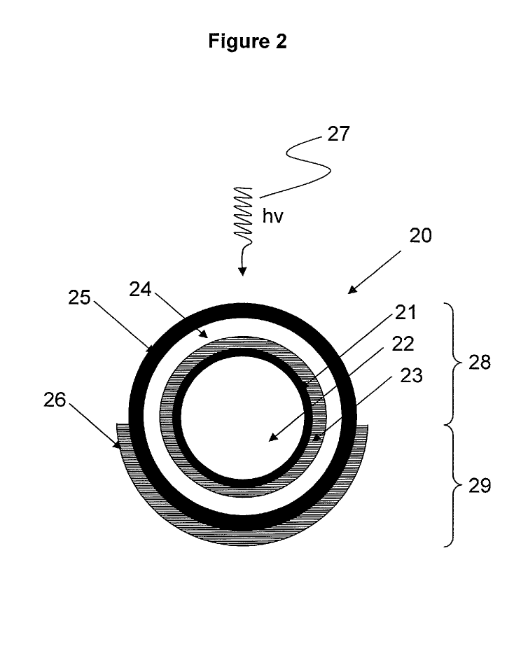

FIG. 2 illustrates a cross sectional view of an apparatus according to another embodiment described herein. The apparatus (20) illustrated in FIG. 2 comprises a conduit core (21) and a fluid (22) disposed in the conduit core (21). A photoactive assembly is coupled to and at least partially surrounds the conduit core (21). In the embodiment of FIG. 2, the photoactive assembly comprises a radiation transmissive first electrode (23), a photosensitive layer (25) electrically connected to the first electrode (23), and a second electrode (26) electrically connected to the photosensitive layer (25). An exciton blocking layer (24) described further herein is disposed between the radiation transmissive first electrode (23) and the photosensitive layer (25). The radiation transmissive first electrode (23), exciton blocking layer (24), and photosensitive layer (25) completely surround the exterior of the conduit core (21), while the second electrode (26) surrounds about 50 percent of the exterior of the conduit core (21).

Like the apparatus of FIG. 1, the apparatus (20) of FIG. 2 is operable to receive electromagnetic radiation (27) at one or more points at a side of the conduit core (21) or along a circumferential area of the conduit core (21), such as at a front side (28) of the conduit core, as opposed to a back side (29) of the conduit core.

Turning now to components that can be included in the various embodiments of apparatus described herein, apparatus described herein comprise a conduit core comprising at least one radiation transmissive surface. In some embodiments, all or substantially all of the surfaces of a conduit core are radiation transmissive. In some embodiments, a conduit core is constructed from a radiation transmissive material. Suitable radiation transmissive materials, in some embodiments, comprise glass, quartz or polymeric materials. A radiation transmissive polymeric material, in some embodiments, comprises polyacrylic acid, polymethacrylate, polymethyl methacrylate or copolymers or mixtures thereof. In some embodiments, a radiation transmissive polymeric material comprises polycarbonate, polystyrene or perfluorocyclobutane (PFBC) containing polymers, such as perfluorocyclobutane poly(arylether)s.

In some embodiments, a conduit core can have any desired dimensions. In some embodiments, a conduit core has an inner diameter of at least about 0.1 mm. In some embodiments, a conduit core has an inner diameter of at least about 0.5 mm or at least about 1 mm. In some embodiments, a conduit core has an inner diameter of about 1.5 mm. In some embodiments, a conduit core has an inner diameter of at least about 10 mm or at least about 100 mm. In some embodiments, a conduit core has an inner diameter of at least about 1 cm or at least about 10 cm. A conduit core, in some embodiments, has an inner diameter of at least about 100 cm or at least about 1 m. In some embodiments, a conduit core has an inner diameter ranging from about 0.1 mm to about 1 m.

In some embodiments, a conduit core has a length of at least about 0.5 mm. In some embodiments, a conduit core has a length of at least about 1 mm or at least about 10 mm. In some embodiments, a conduit core has a length of at least about 1 cm or at least about 10 cm. In some embodiments, a conduit core has a length of at least about 500 cm or at least about 1 m. A conduit core, in some embodiments, has a length ranging from about 0.5 mm to about 10 m.

Moreover, a conduit core can have any desired cross-sectional shape. In some embodiments, a conduit core has a circular or elliptical cross-sectional shape. In some embodiments, a conduit core has polygonal cross-sectional shape including, but not limited to, triangular, square, rectangular, parallelogram, trapezoidal, pentagonal or hexagonal. In some embodiments, a conduit core is closed or capped at one end or capped at both ends. A conduit core, in some embodiments is not capped at one end or both ends to permit the fluid of the apparatus to flow through the conduit core as described further herein.

Apparatus described herein also comprise a fluid disposed in the conduit core. In some embodiments, a fluid disposed in the conduit core is radiation transmissive, thereby transmitting at least a portion of radiation received by the apparatus to the photoactive assembly. Moreover, in some embodiments, a fluid is operable to alter the path of at least a portion of electromagnetic radiation received by the apparatus. In some embodiments, for example, a fluid has an index of refraction different from the index of refraction of the conduit core. In some embodiments, a fluid has an index of refraction greater than the index of refraction of the conduit core. In some embodiments, a fluid has an index of refraction less than the index of refraction of the conduit core. In some embodiments, a fluid is operable to focus or concentrate at least a portion of electromagnetic radiation received by the apparatus. Focusing or concentrating at least a portion of electromagnetic radiation received by the apparatus, in some embodiments, can increase the total intensity of radiation or the intensity of radiation per area transmitted into the photoactive assembly.

In some embodiments, a fluid disposed in the conduit core is operable to absorb at least a portion of the radiation received by the apparatus. In some embodiments, for example, a fluid disposed in the conduit core is operable to absorb radiation having one or more wavelengths in the infrared region of the electromagnetic spectrum. In some embodiments, a fluid is operable to absorb near infrared radiation (NIR), mid-wave infrared radiation (MWIR) or long wave infrared radiation (LWIR) or combinations thereof. In some embodiments, a fluid disposed in the conduit core is operable to absorb radiation having one or more wavelengths in the visible and/or ultraviolet (UV) regions of the electromagnetic spectrum. In some embodiments, the radiation absorption profile of a fluid does not overlap with the radiation absorption profile of a photosensitive layer of the photoactive assembly. In some embodiments, the radiation absorption profile of a fluid at least partially overlaps with the radiation absorption profile of a photosensitive layer of the photoactive assembly.

In some embodiments, the absorption of radiation by the fluid disposed in the conduit core generates thermal energy. In some embodiments, thermal energy generated in the fluid can be captured by transferring the heated fluid to a heat exchanger or similar device. In some embodiments, a fluid disposed in the conduit core comprises one or more Stokes shift materials operable to contribute to the thermal energy of the fluid. Moreover, in some embodiments, the radiation emitted by one or more Stokes shift materials of the fluid may be absorbed by a photosensitive layer of the photoactive assembly.

Any Stokes shift material not inconsistent with the objectives of the present invention can be used for incorporation into the fluid. In some embodiments, suitable Stokes shift materials are selected according to absorption and emission profiles. In some embodiments, the absorption profile of a Stokes shift material does not overlap with the absorption profile of a photosensitive layer of the photoactive assembly. In some embodiments, the absorption profile of a Stokes shift material at least partially overlaps with the absorption profile of a photosensitive layer of the photoactive assembly. Additionally, in some embodiments, a Stokes shift material has an emission profile that at least partially overlaps with the absorption profile of a photosensitive layer of the photoactive assembly.

In some embodiments, a Stokes shift material is operable to absorb radiation in the near ultraviolet region of the electromagnetic spectrum. In some embodiments, for example, a Stokes shift material absorbs radiation having a wavelength ranging from about 300 nm to about 400 nm.

In some embodiments, a Stokes shift material comprises a dye. Any dye not inconsistent with the objectives of the present invention may be used. In some embodiments, for example, a dye comprises one or more of coumarins, coumarin derivatives, pyrenes, and pyrene derivatives. In some embodiments, a Stokes shift material comprises an ultraviolet light-excitable fluorophore. Non-limiting examples of dyes suitable for use in some embodiments described herein include methoxycoumarin, dansyl dyes, pyrene, Alexa Fluor 350, aminomethylcoumarin acetate (AMCA), Marina Blue dye, Dapoxyl dyes, dialkylaminocoumarin, bimane dyes, hydroxycoumarin, Cascade Blue dye, Pacific Orange dye, Alexa Fluor 405, Cascade Yellow dye, Pacific Blue dye, PyMPO, and Alexa Fluor 430.

In some embodiments, a Stokes shift material comprises a phosphor. Any phosphor not inconsistent with the objectives of the present invention may be used. In some embodiments, for example, a phosphor comprises one or more of halophosphate phosphors and triphosphors. Non-limiting examples of phosphors suitable for use in some embodiments described herein include Ca₅(PO₄)₃(F, Cl):Sb³⁺, Mn²⁺; Eu:Y₂O₃; and Tb³⁺, Ce³⁺:LaPO₄. In some embodiments, a phosphor comprises a phosphor particle. Phosphor particles, in some embodiments, can be suspended in a fluid.

In some embodiments, a fluid disposed in the conduit core comprises a liquid. Any liquid not inconsistent with the objectives of the present invention can be used as a fluid disposed in the conduit core. In some embodiments, a liquid has an index of refraction different than the index of the conduit core. In some embodiments, a liquid has a higher index of refraction than the conduit core. Further, in some embodiments, a liquid has a high heat capacity (C). In some embodiments, a liquid comprises a thermal liquid. In some embodiments, a liquid comprises an organic thermal liquid. In some embodiments, a liquid comprises an oil including, but not limited to, a silicone oil, mineral oil, saturated hydrocarbon oil, unsaturated hydrocarbon oil or mixtures thereof. In some embodiments, a silicone oil comprises polydimethoxysiloxane. In some embodiments, a mineral oil comprises hydrotreated mineral oil. In some embodiments, a liquid comprises aromatic compounds. In some embodiments, a liquid comprises one or more of paraffinic hydrocarbons, hydrotreated heavy paraffinic distillate, linear alkenes, di- and tri-aryl ethers, partially hydrogenated terphenyl, diaryl dialkyl compounds, diphenyl ethane, diphenyl oxide, and alkylated aromatics such as alkylated biphenyls, diethyl benzene, and C₁₄ to C₃₀ alkyl benzene derivatives.

In some embodiments, a liquid comprises glycol, such as ethylene glycol, propylene glycol, and/or polyalkylene glycol. In some embodiments, a liquid comprises water. In some embodiments, a liquid comprises an ionic liquid. Non-limiting examples of ionic liquids suitable for use in some embodiments described herein include 1-butyl-3-methylimidazolium tetrafluoroborate, 1-octyl-3-methylimidazolium tetrafluoroborate, 1-decyl-3-methylimidazolium tetrafluoroborate, 1-butyl-3-methylimidazolium bistrifluoromethane sulfonimide, 1-butyl-3-methylimidazolium hexafluorophosphate, 1-octyl-3-methylimidazolium hexafluorophosphate, 1-decyl-3-methylimidazolium hexafluorophosphate, 1-butyl-3-methylimidazolium tetrachloroaluminum, and combinations thereof.

In some embodiments, a fluid disposed in the conduit core comprises a gas. Any gas not inconsistent with the objectives of the present invention can be used as a fluid disposed in the conduit core.

The choice of fluid, in some embodiments, can be based on several considerations including, but not limited to the heat capacity of the liquid, the electromagnetic absorption profile of the liquid, the viscosity of the liquid and/or the index of refraction of the liquid.

Apparatus described herein also comprise a photoactive assembly at least partially surrounding the conduit core. In some embodiments, the photoactive assembly comprises a radiation transmissive first electrode, at least one photosensitive layer electrically connected to the first electrode, and a second electrode electrically connected to the photosensitive layer. In some embodiments, the photoactive assembly comprises a plurality of photosensitive layers connected to the first electrode. In some embodiments, the photoactive assembly further comprises at least one photosensitive layer not electrically connected to the first electrode and/or the second electrode.

In at least partially surrounding the conduit core, a photoactive assembly of apparatus described herein, in some embodiments, is coupled to the conduit core. In some embodiments, for example, the photoactive assembly is disposed on a surface of the conduit core. In some embodiments, the photoactive assembly surrounds up to about 95 percent of the exterior of the conduit core. In some embodiments, the photoactive assembly surrounds up to about 70 percent or up to about 60 percent of the exterior of the conduit core. In some embodiments, the photoactive assembly surrounds up to about 50 percent or up to about 35 percent of the exterior of the conduit core. In some embodiments, the photoactive assembly surrounds up to about 25 percent of the exterior of the conduit core. In some embodiments, the photoactive assembly surrounds at least about 5 percent or at least about 10 percent of the exterior of the conduit core. In some embodiments, the photoactive assembly surrounds about 1 percent to about 50 percent of the exterior of the conduit core.

In at least partially surrounding the conduit core, the photoactive assembly, in some embodiments, has a curvature matching or substantially matching the curvature or the outer surface of the conduit core. Moreover, in some embodiments, the photoactive assembly does not comprise a fiber structure or construction.

In some embodiments, not all of the components of a photoactive assembly surround the same amount of the exterior of the conduit core. In some embodiments, for example, the radiation transmissive first electrode, the at least one photosensitive layer, and the second electrode of a photoactive assembly surround the same or substantially the same amount of the exterior of the conduit core (such as in the embodiment of FIG. 1). Alternatively, in some embodiments, the radiation transmissive first electrode, the at least one photosensitive layer, and the second electrode of a photoactive assembly surround different amounts of the exterior of the conduit core (such as in the embodiment of FIG. 2). In some embodiments, the radiation transmissive first electrode, the at least one photosensitive layer, and the second electrode of a photoactive assembly each surround about 1 percent to about 50 percent of the exterior of the conduit core.

Further, the components of a photoactive assembly described herein can be arranged about the conduit core in any manner not inconsistent with the objectives of the present invention. In some embodiments, the arrangement of one or more components of the photoactive assembly about the conduit core provides increased opportunities for absorption of incident electromagnetic radiation by the photoactive assembly. For example, in some embodiments, at least one photosensitive layer of the photoactive assembly completely surrounds the conduit core, requiring incident radiation to pass through the photosensitive layer before reaching the conduit core. In some embodiments, at least one photosensitive layer of the photoactive assembly surrounds more than about 50 percent of the exterior of the conduit core. In other embodiments, at least one photosensitive layer surrounds up to about 95 percent, up to about 90 percent, up to about 80 percent, or up to about 70 percent of the exterior of the conduit core. Therefore, in some embodiments, the components of a photoactive assembly can be arranged to permit at least a portion of incident radiation to pass through a photosensitive layer on the front side of a conduit core as well as on the back side of the conduit core. The front side of a conduit core, in some embodiments, refers to the side of the conduit core closer to the incident radiation received by the conduit core, as illustrated, for example, in FIG. 2.

Moreover, in some embodiments described herein wherein at least one photosensitive layer surrounds more than about 50 percent of the exterior of the conduit core, one or more other components of the photoactive assembly do not surround more than about 50 percent of the exterior of the conduit core. For example, in some embodiments, the second electrode surrounds no more than about 50 percent of the exterior of the conduit core.

Further, in some embodiments described herein wherein at least one photosensitive layer surrounds more than about 50 percent of the exterior of the conduit core, the photosensitive layer present on the front side of the conduit core does not diminish or inhibit the ability of the fluid disposed in the conduit core to direct at least a portion of received radiation into the photosensitive layer present on the back side of the conduit core. In some embodiments, the photosensitive layer present on the front side of the conduit core increases or enhances the ability of the fluid disposed in the conduit core to direct at least a portion of received radiation into the photosensitive layer on the back side of the conduit core. In some embodiments, the relative indices of refraction of the fluid, the conduit core, and the photosensitive layer affect the ability of the fluid disposed in the conduit core to direct radiation into the photosensitive layer on the back side of the conduit core.

In some embodiments comprising at least one photosensitive layer on the front side of a conduit core, the photosensitive layer on the front side of the conduit core is electrically connected to both of the radiation transmissive first electrode and the second electrode. Therefore, in some embodiments, charge carriers generated in a photosensitive layer on the front side of a conduit core can be extracted through one or more of the radiation transmissive first electrode and the second electrode. In some embodiments, a photoactive assembly described herein further comprises a third electrode electrically connected to a photosensitive layer on the front side of the conduit core. Therefore, in some embodiments, charge carriers generated in a photosensitive layer on the front side of a conduit core can be extracted through the third electrode. In some embodiments, for example, a photosensitive layer on the front side of the conduit core is discontinuous with the photosensitive layer on the back side of the conduit core.

In addition, the presence of at least one photosensitive layer on the front side of a conduit core can, in some embodiments, provide multispectral characteristics to the photoactive assembly. For example, in some embodiments, a photosensitive layer present on the front side of a conduit core can comprise a different material than the photosensitive layer present on the back side of the conduit core. In some embodiments, the absorption profile of the photosensitive layer present on the front side of a conduit core does not overlap or does not substantially overlap with the absorption profile of the photosensitive layer present on the back side of the conduit core. In some embodiments, for instance, the photosensitive layer present on the front side of a conduit core is operable to absorb electromagnetic radiation in one region of the visible spectrum that does not overlap or only partially overlaps with the region of the visible spectrum absorbed by the backside photosensitive layer. Therefore, in some embodiments, a photoactive assembly comprising at least one photosensitive layer on the front side of a conduit core and at least one photosensitive layer on the back side of the conduit core can be used to capture a plurality of regions of the solar spectrum.

A radiation transmissive first electrode, according to some embodiments, comprises a radiation transmissive conducting oxide. Radiation transmissive conducting oxides, in some embodiments, can comprise indium tin oxide (ITO), gallium indium tin oxide (GITO), and zinc indium tin oxide (ZITO). In another embodiment, a radiation transmissive first electrode can comprise a radiation transmissive polymeric material such as polyanaline (PANI) and its chemical relatives.

In some embodiments, 3,4-polyethylenedioxythiophene (PEDOT) can be a suitable radiation transmissive polymeric material for the first electrode. In other embodiments, a radiation transmissive first electrode can comprise a carbon nanotube layer having a thickness operable to at least partially pass visible electromagnetic radiation.

In another embodiment, a radiation transmissive first electrode can comprise a composite material comprising a nanoparticle phase dispersed in a polymeric phase. The nanoparticle phase, in one embodiment, can comprise carbon nanotubes, fullerenes, or mixtures thereof. In a further embodiment, a radiation transmissive first electrode can comprise a metal layer having a thickness operable to at least partially pass visible electromagnetic radiation. In some embodiments, a metal layer can comprise elementally pure metals or alloys. Metals suitable for use as a radiation transmissive first electrode can comprise high work function metals.

In some embodiments, a radiation transmissive first electrode can have a thickness ranging from about 10 nm to about 1 μm. In other embodiments, a radiation transmissive first electrode can have a thickness ranging from about 100 nm to about 900 nm. In another embodiment, a radiation transmissive first electrode can have a thickness ranging from about 200 nm to about 800 nm. In a further embodiment, a radiation transmissive first electrode can have a thickness greater than 1 μm.

In some embodiments of a photoactive assembly, the at least one photosensitive layer comprises an organic composition. In some embodiments, a photosensitive organic layer has a thickness ranging from about 30 nm to about 1 μm. In other embodiments, a photosensitive organic layer has a thickness ranging from about 80 nm to about 800 nm. In a further embodiment, a photosensitive organic layer has a thickness ranging from about 100 nm to about 300 nm.

A photosensitive organic layer, according to some embodiments, comprises at least one photoactive region in which electromagnetic radiation is absorbed to produce excitons which may subsequently dissociate into electrons and holes. In some embodiments, a photoactive region can comprise a polymer. Polymers suitable for use in a photoactive region of a photosensitive organic layer, in one embodiment, can comprise conjugated polymers such as thiophenes including poly(3-hexylthiophene) (P3HT), poly(3-octylthiophene) (P3OT), and polythiophene (PTh).

In some embodiments, polymers suitable for use in a photoactive region of a photosensitive organic layer can comprise semiconducting polymers. In some embodiments, semiconducting polymers include phenylene vinylenes, such as poly(phenylene vinylene) and poly(p-phenylene vinylene) (PPV), and derivatives thereof. In some embodiments, semiconducting polymers can comprise poly fluorenes, naphthalenes, and derivatives thereof. In a further embodiment, semiconducting polymers for use in a photoactive region of a photosensitive organic layer can comprise poly(2-vinylpyridine) (P2VP), polyamides, poly(N-vinylcarbazole) (PVCZ), polypyrrole (PPy), and polyaniline (PAn). In some embodiments, a semiconducting polymer comprises poly[2,6-(4,4-bis-(2-ethylhexyl)-4H-cyclopenta[2,1-b;3,4-b′]dithiophene)-alt-4,7-(2,1,3-benzothiadiazole)] (PCPDTBT).

A photoactive region, according to some embodiments, can comprise small molecules. In one embodiment, small molecules suitable for use in a photoactive region of a photosensitive organic layer can comprise coumarin 6, coumarin 30, coumarin 102, coumarin 110, coumarin 153, and coumarin 480 D. In another embodiment, a small molecule can comprise merocyanine 540. In a further embodiment, small molecules can comprise 9,10-dihydrobenzo[a]pyrene 7(8H)-one, 7-methylbenzo[a]pyrene, pyrene, benzo[e]pyrene, 3,4-dihydroxy-3-cyclobutene-1,2-dione, and 1,3-bis[4-(dimethylamino)phenyl-2,4-dihydroxy-cyclobutenediylium dihydroxide.

In some embodiments, exciton dissociation is precipitated at heterojunctions in the organic layer formed between adjacent donor and acceptor materials. Organic layers, in some embodiments, comprise at least one bulk heterojunction formed between donor and acceptor materials. In other embodiments, organic layers comprise a plurality of bulk heterojunctions formed between donor and acceptor materials.

In the context of organic materials, the terms donor and acceptor refer to the relative positions of the highest occupied molecular orbital (HOMO) and lowest unoccupied molecular orbital (LUMO) energy levels of two contacting but different organic materials. This is in contrast to the use of these terms in the inorganic context, where donor and acceptor may refer to types of dopants that may be used to create inorganic n- and p-type layers, respectively. In the organic context, if the LUMO energy level of one material in contact with another is lower, then that material is an acceptor. Otherwise it is a donor. It is energetically favorable, in the absence of an external bias, for electrons at a donor-acceptor junction to move into the acceptor material, and for holes to move into the donor material.

A photoactive region in a photosensitive organic layer, according to some embodiments, comprises a polymeric composite material. The polymeric composite material, in one embodiment, can comprise a nanoparticle phase dispersed in a polymeric phase. Polymers suitable for producing the polymeric phase of a photoactive region can comprise conjugated polymers such as thiophenes including poly(3-hexylthiophene) (P3HT) and poly(3-octylthiophene) (P3OT).

In some embodiments, the nanoparticle phase dispersed in the polymeric phase of a polymeric composite material comprises at least one carbon nanoparticle. Carbon nanoparticles can comprise fullerenes, carbon nanotubes, or mixtures thereof. Fullerenes suitable for use in the nanoparticle phase, in one embodiment, can comprise 1-(3-methoxycarbonyl)propyl-1-phenyl(6,6)C₆₁ (PCBM) or C₇₀ fullerenes or mixtures thereof. Carbon nanotubes for use in the nanoparticle phase, according to some embodiments, can comprise single-walled nanotubes, multi-walled nanotubes, or mixtures thereof.

In some embodiments, the polymer to nanoparticle ratio in polymeric composite materials ranges from about 1:10 to about 1:0.1. In some embodiments, the polymer to nanoparticle ratio in polymeric composite materials ranges from about 1:4 to about 1:0.4. In some embodiments, the polymer to nanoparticle ratio in polymeric composite materials ranges from about 1:2 to about 1:0.6. In one embodiment, for example, the ratio of poly(3-hexylthiophene) to PCBM ranges from about 1:1 to about 1:0.4.

In a further embodiment, the nanoparticle phase dispersed in the polymeric phase comprises at least one nanowhisker. A nanowhisker, as used herein, refers to a crystalline carbon nanoparticle formed from a plurality of carbon nanoparticles. Nanowhiskers, in some embodiments, can be produced by annealing a photosensitive organic layer comprising the polymeric composite material. Carbon nanoparticles operable to form nanowhiskers, according to some embodiments, can comprise single-walled carbon nanotubes, multi-walled carbon nanotubes, and fullerenes. In one embodiment, nanowhiskers comprise crystalline PCBM. Annealing the photosensitive organic layer, in some embodiments, can further increase the dispersion of the nanoparticle phase in the polymeric phase.

In embodiments of photoactive regions comprising a polymeric phase and a nanoparticle phase, the polymeric phase serves as a donor material and the nanoparticle phase serves as the acceptor material thereby forming a heterojunction for the separation of excitons into holes and electrons. In embodiments wherein nanoparticles are dispersed throughout the polymeric phase, the photoactive region of the organic layer comprises a plurality of bulk heterojunctions.

In further embodiments, donor materials in a photoactive region of a photosensitive organic layer can comprise organometallic compounds including porphyrins, phthalocyanines, and derivatives thereof. In further embodiments, acceptor materials in a photoactive region of a photosensitive organic layer can comprise perylenes, naphthalenes, and mixtures thereof.

In some embodiments, the at least one photosensitive layer comprises an inorganic composition. The inorganic composition, in some embodiments, can exhibit various structures. In some embodiments, for example, the inorganic composition comprises an amorphous material. In other embodiments, the inorganic composition comprises a crystalline material. In some embodiments, the inorganic composition comprises a single crystalline material. In other embodiments, the inorganic composition comprises a polycrystalline material.

In some embodiments, a polycrystalline material comprises microcrystalline grains, nanocrystalline grains or combinations thereof. In some embodiments, for example, a polycrystalline material has a grain size less than about 1 μm. In some embodiments, a polycrystalline material has an average grain size less than about 500 nm, less than about 300 nm, less than about 250 nm, or less than about 200 nm. In some embodiments, a polycrystalline material has an average grain size less than about 100 nm. In some embodiments, a polycrystalline material has an average grain size between about 5 nm and about 1 μm. In some embodiments, a polycrystalline material has an average grain size between about 10 nm and about 500 nm, between about 50 nm and about 250 nm, or between about 50 nm and about 150 nm. In some embodiments, a polycrystalline material has an average grain size between about 10 nm and about 100 nm or between about 10 nm and about 80 nm. In some embodiments, a polycrystalline material has an average grain size greater than 1 μm. A polycrystalline material, in some embodiments, has an average grain size ranging from about 1 μm to about 50 μm or from about 1 μm to about 10 μm.

Further, the inorganic composition can exhibit various compositions. In some embodiments, the inorganic composition comprises a group IV semiconductor material, a group II/VI semiconductor material (such as CdTe), a group III/V semiconductor material, or combinations or mixtures thereof. In some embodiments, an inorganic composition comprises a group IV, group II/VI, or group III/V binary, ternary or quaternary system. In some embodiments, an inorganic composition comprises a I/III/VI material, such as copper indium gallium selenide (CIGS). In some embodiments, an inorganic composition comprises polycrystalline silicon (Si). In some embodiments, an inorganic composition comprises microcrystalline, nanocrystalline, and/or protocrystalline silicon. In some embodiments, the inorganic composition comprises amorphous silicon (a-Si). The amorphous silicon, in some embodiments, is unpassivated or substantially unpassivated. In other embodiments, the amorphous silicon is passivated with hydrogen (a-Si:H) and/or a halogen, such as fluorine (a-Si:F). In some embodiments, an inorganic composition comprises polycrystalline copper zinc tin sulfide (CZTS), such as microcrystalline, nanocrystalline, and/or protocrystalline CZTS. In some embodiments, the CZTS comprises Cu₂ZnSnS₄. In some embodiments, the CZTS further comprises selenium (Se). In some embodiments, the CZTS further comprises gallium (Ga). In some embodiments, any of the foregoing crystalline materials of the photosensitive inorganic layer can have any grain size described herein.

Moreover, a photosensitive inorganic layer can have any thickness not inconsistent with the objectives of the present invention. In some embodiments, for example, a photosensitive inorganic layer has a thickness ranging from about 10 nm to about 5 μm. In other embodiments, a photosensitive inorganic layer has a thickness ranging from about 20 nm to about 500 nm or from about 25 nm to about 100 nm.

In some embodiments, a photoactive assembly described herein comprises a plurality of photosensitive layers. In some embodiments, for example, a photoactive assembly comprises a plurality of organic photosensitive layers. In some embodiments, a photoactive assembly comprises a plurality of inorganic photosensitive layers. In some embodiments, a photoactive assembly comprises a combination of at least one organic photosensitive layer and at least one inorganic photosensitive layer.

In some embodiments wherein a plurality of photosensitive layers are present in a photoactive assembly, the absorption profiles of the photosensitive layers do not overlap or do not substantially overlap. In some embodiments wherein a plurality of photosensitive layer are present in a photoactive assembly, the absorption profiles of the photosensitive layers at least partially overlap. In some embodiments, a plurality of photosensitive layers can be used to capture one or more regions of the solar spectrum.

Moreover, the second electrode of a photoactive assembly, in some embodiments, comprises a metal. As used herein, metal refers to both materials composed of an elementally pure metal (e.g., gold, silver, platinum, aluminum) and also metal alloys comprising materials composed of two or more elementally pure materials. In some embodiments, the second electrode comprises gold, silver, aluminum, or copper. The second electrode, according to some embodiments, can have a thickness ranging from about 10 nm to about 10 μm. In some embodiments, the second electrode can have a thickness ranging from about 100 nm to about 1 μm. In a further embodiment, the second electrode can have a thickness ranging from about 200 nm to about 800 nm.

In some embodiments, the second electrode is non-radiation transmissive. In some embodiments, for example, the second electrode is operable to reflect radiation not absorbed by the photosensitive layer back into the photosensitive layer for additional opportunities of absorption. In some embodiments, the second electrode is operable to reflect radiation not absorbed by the fluid of the conduit core back into the fluid for additional opportunities of absorption.

A layer comprising lithium fluoride (LiF), according to some embodiments, can be disposed between a photosensitive layer and second electrode. In some embodiments, for example, an LiF layer is disposed between a photosensitive organic layer and the second electrode. In some embodiments, the LiF layer can have a thickness ranging from about 5 angstroms to about 10 angstroms.

In some embodiments, the LiF layer can be at least partially oxidized, resulting in a layer comprising lithium oxide (Li₂O) and LiF. In other embodiments, the LiF layer can be completely oxidized, resulting in a lithium oxide layer deficient or substantially deficient of LiF. In some embodiments, a LiF layer is oxidized by exposing the LiF layer to oxygen, water vapor, or combinations thereof. In one embodiment, for example, a LiF layer is oxidized to a lithium oxide layer by exposure to an atmosphere comprising water vapor and/or oxygen at partial pressures of less than about 10⁻⁶ Torr. In another embodiment, a LiF layer is oxidized to a lithium oxide layer by exposure to an atmosphere comprising water vapor and/or oxygen at partial pressures less than about 10⁻⁸ Torr.

In some embodiments, a LiF layer is exposed to an atmosphere comprising water vapor and/or oxygen for a time period ranging from about 1 hour to about 15 hours. In one embodiment, a LiF layer is exposed to an atmosphere comprising water vapor and/or oxygen for a time period greater than about 15 hours. In a further embodiment, a LiF layer is exposed to an atmosphere comprising water vapor and/or oxygen for a time period less than about one hour. The time period of exposure of the LiF layer to an atmosphere comprising water vapor and/or oxygen, according to some embodiments, is dependent upon the partial pressures of the water vapor and/or oxygen in the atmosphere. The higher the partial pressure of the water vapor or oxygen, the shorter the exposure time.

Apparatus described herein, in some embodiments, can further comprise additional layers, such as one or more exciton blocking layers. In some embodiments, an exciton blocking layer (EBL) can act to confine photogenerated excitons to the region near the dissociating interface and prevent parasitic exciton quenching at a photosensitive layer/electrode interface. In addition to limiting the path over which excitons may diffuse, an EBL can additionally act as a diffusion barrier to substances introduced during deposition of the electrodes. In some embodiments, an EBL can have a sufficient thickness to fill pin holes or shorting defects which could otherwise render a photovoltaic apparatus inoperable.

An EBL, according to some embodiments, can comprise a polymeric composite material. In one embodiment, an EBL comprises carbon nanoparticles dispersed in 3,4-polyethylenedioxythiophene:polystyrenesulfonate (PEDOT:PSS). In another embodiment, an EBL comprises carbon nanoparticles dispersed in poly(vinylidene chloride) and copolymers thereof. Carbon nanoparticles dispersed in the polymeric phases including PEDOT:PSS and poly(vinylidene chloride) can comprise single-walled nanotubes, multi-walled nanotubes, fullerenes, or mixtures thereof. In further embodiments, EBLs can comprise any polymer having a work function energy operable to permit the transport of holes while impeding the passage of electrons.

In some embodiments, an EBL may be disposed between the radiation transmissive first electrode and a photosensitive layer of a photoactive assembly. In some embodiments wherein the apparatus comprises a plurality of photosensitive organic layers, for example, EBLs can be disposed between the photosensitive organic layers.

An apparatus described herein, in some embodiments, can further comprise a protective layer surrounding the second electrode. The protective layer can provide an apparatus with increased durability thereby permitting its use in a wide variety of applications including photovoltaic applications. In some embodiments, the protective layer comprises a polymeric composite material. In one embodiment, the protective layer comprises nanoparticles dispersed in poly(vinylidene chloride). Nanoparticles dispersed in poly(vinylidene chloride), according to some embodiments, can comprise single-walled carbon nanotubes, multi-walled carbon nanotubes, fullerenes, or mixtures thereof.

An apparatus described herein, in some embodiments, can further comprise an external metallic contact. In one embodiment, an external metallic contact is coextensive with the second electrode and is in electrical communication with the second electrode. The external metallic contact, in some embodiments, can be operable to extract current over at least a portion of the circumference and length of the apparatus. External metallic contacts, in some embodiments, can comprise metals including gold, silver, aluminum or copper. In a further embodiment, external metal contacts can be operable to reflect non-absorbed electromagnetic radiation back into at least one photosensitive layer and/or conduit fluid for further absorption.

In some embodiments, apparatus described herein can further comprise charge transfer layers. Charge transfer layers, as used herein, refer to layers which only deliver charge carriers from one section of an apparatus to another section. In one embodiment, for example, a charge transfer layer can comprise an exciton blocking layer.

A charge transfer layer, in some embodiments, can be disposed between a photosensitive layer and radiation transmissive first electrode and/or a photosensitive layer and second electrode. In some embodiments, charge transfer layers may be disposed between the second electrode and protective layer of an apparatus described herein. Charge transfer layers, according to some embodiments, are not photoactive.

In some embodiments, an apparatus described herein is coupled to a heat exchanger or other apparatus, including thermoelectric apparatus or thermocouple, operable to capture thermal energy generated in the fluid disposed in the conduit core. In some embodiments, a thermoelectric apparatus is coupled to the photoactive assembly. Moreover, in some embodiments, a thermoelectric apparatus is in thermal contact with the fluid of the conduit core downstream of the photoactive assembly.

As a result, apparatus described herein, in some embodiments, have the ability to produce electrical energy and thermal energy. In some embodiments, an apparatus described herein has a solar-thermal efficiency of at least about 15 percent. In some embodiments, an apparatus described herein has a solar-thermal efficiency of at least about 20 percent or at least about 25 percent. In some embodiments, an apparatus described herein has a solar-thermal efficiency up to about 40 percent. In some embodiments, an apparatus described herein has a solar-thermal efficiency ranging from about 5 percent to about 35 percent. In some embodiments, an apparatus described herein has a solar-thermal efficiency ranging from about 10 percent to about 30 percent.

The solar-thermal efficiency of an apparatus described herein, in some embodiments, is determined according to the equation:

$${η}_{th} = \frac{{W}_{u}}{G \cdot {A}_{C}} = \frac{Δ {Q}_{u} / Δ t}{G \cdot {A}_{C}} = \frac{m \cdot {C}_{p} \cdot Δ T / Δ t}{G \cdot {A}_{C}} = \frac{m \cdot {C}_{p}}{G \cdot {A}_{C}} \cdot {T}^{′} ( t )$$

where Wᵤ is the heat collected, G is solar irradiance, Cₚ is the specific heat capacity of the fluid in the conduit core and A_{c} is the collector area. When the fluid is flowing within the conduit core according to some embodiments described herein, the solar-thermal efficiency can be described according to the equation:

$${η}_{th} = \frac{v \cdot π \cdot {r}^{2} \cdot ρ \cdot {C}_{p}}{G \cdot {A}_{C}} \cdot {T}^{′} ( 1 / υ )$$

where ν is flow rate. Additional discussion of photo-thermal conversion can be found in Charalambous, P. G.; Maidment, G. G.; Kalogirou, S. A.; Yiakoumetti, K., “Photovoltaic thermal (PV/T) collectors: a review,” Applied Thermal Engineering, 2007, 27, 275-286. The total power converted by an apparatus described herein can be determined by adding the power from the photo-thermal conversion (ηₜₕ) and that of the photo-electric conversion (ηₑₗ).

In another aspect, a photovoltaic apparatus comprising a plurality of photovoltaic cells is described herein, wherein at least one of the photovoltaic cells comprises a conduit core comprising at least one radiation transmissive surface, a fluid disposed in the conduit core, and a photoactive assembly at least partially surrounding the conduit core, the photoactive assembly comprising a radiation transmissive first electrode, at least one photosensitive layer electrically connected to the first electrode, and a second electrode electrically connected to the photosensitive layer. Individual components of the at least one photovoltaic cell of the present photovoltaic apparatus, such as the conduit core, fluid and photoactive assembly, can comprise any of the constructions and functionalities described herein for the same.

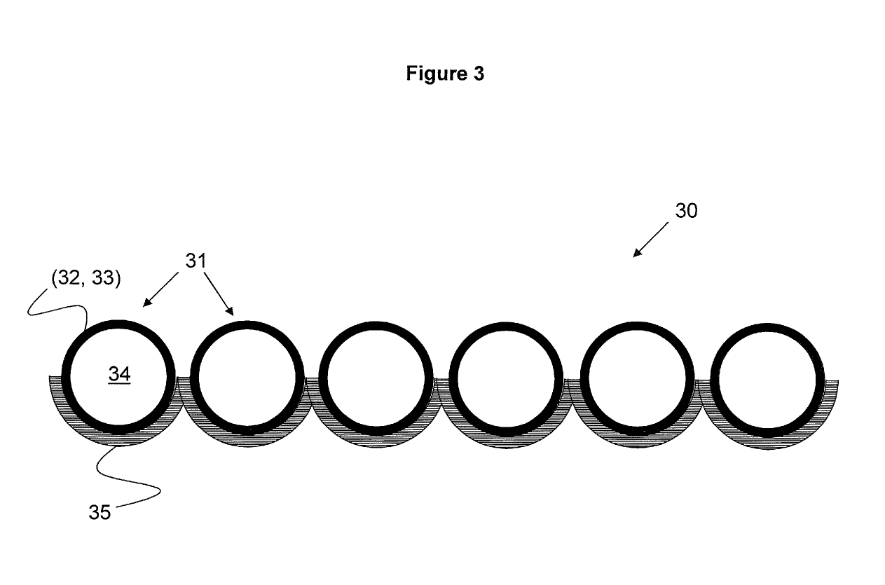

FIG. 3 illustrates a photovoltaic apparatus comprising a plurality of photovoltaic cells according to one embodiment described herein. The photovoltaic apparatus (30) illustrated in FIG. 3 comprises a plurality of photovoltaic cells (31), wherein each photovoltaic cell comprises a conduit core (32) comprising at least one radiation transmissive surface (33), a fluid (34) disposed in the conduit core (32) and a photoactive assembly (35) having a construction described herein at least partially surrounding the conduit core (32).

The photovoltaic cells (31) are operable to receive electromagnetic radiation at one or more points at a side of the conduit cores (32) or along a circumferential area of the conduit cores (32) as opposed to receiving electromagnetic radiation along the longitudinal axis of the conduit cores (32).

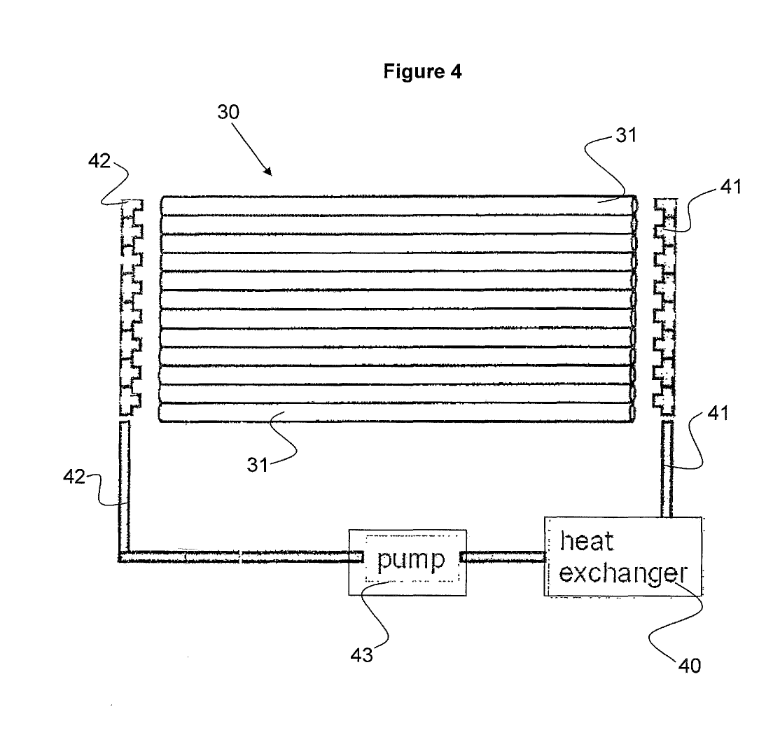

In some embodiments, a photovoltaic apparatus described herein is coupled to a heat exchanger, thermoelectric apparatus and/or other apparatus operable to capture thermal energy generated in the fluid disposed in the conduit core. FIG. 4 illustrates the photovoltaic apparatus (30) of FIG. 3 coupled to a heat exchanger (40) according to one embodiment described herein. In the embodiment illustrated in FIG. 4, each photovoltaic cell (31) is coupled to piping (41) permitting fluid (not shown) comprising thermal energy harvested from the solar spectrum while residing in the photovoltaic cell (31) to be transferred to the heat exchanger (40) for thermal collection. Return piping (42) provides the fluid a pathway back to the photovoltaic cell (31) for further thermal collection. In some embodiments, a pump (43) is used to circulate fluid through the photovoltaic cells (31), piping (41, 42) and the heat exchanger (40).

In another aspect, methods of making photovoltaic apparatus are described herein. In some embodiments, a method of making a photovoltaic apparatus comprises providing a conduit core comprising at least one radiation transmissive surface, disposing a fluid in the conduit core and at least partially surrounding the conduit core with a photoactive assembly, the photoactive assembly comprising a radiation transmissive first electrode, at least one photosensitive layer electrically connected to the first electrode, and a second electrode electrically connected to the photosensitive layer.

In some embodiments, the photoactive assembly is fabricated on the conduit core. In some embodiments, the photoactive assembly is fabricated independently of the conduit core and subsequently coupled to the conduit core.

In some embodiments wherein the photoactive assembly is fabricated on the conduit core, the radiation transmissive electrode is deposited on a surface of the conduit core. In some embodiments, a radiation transmissive first electrode is deposited on a surface of the fiber core by sputtering or dip coating.

The at least one photosensitive layer is disposed in electrical communication with the radiation transmissive first electrode. In some embodiments, an organic photosensitive layer is disposed in electrical communication with the radiation transmissive first electrode by depositing the organic photosensitive layer by dip coating, spin coating, spray coating, vapor phase deposition or vacuum thermal annealing.

Additionally, in some embodiments, photosensitive organic layers are annealed. In some embodiments wherein a photosensitive organic layer comprises a composite material comprising a polymer phase and a nanoparticle phase, annealing the organic layer can produce higher degrees of crystallinity in both the polymer and nanoparticle phases as well as result in greater dispersion of the nanoparticle phase in the polymer phase. Nanoparticle phases comprising fullerenes, single-walled carbon nanotubes, multi-walled carbon nanotubes, or mixtures thereof can form nanowhiskers in the polymeric phase as a result of annealing. Annealing a photosensitive organic layer, according to some embodiments, can comprise heating the organic layer at a temperature ranging from about 80° C. to about 155° C. for a time period ranging from about 1 minute to about 30 minutes. In some embodiments, a photosensitive organic layer can be heated for about 5 minutes.

In some embodiments, an inorganic photosensitive layer is deposited on the radiation transmissive first electrode using one or more standard fabrication methods, including one or more of solution-based methods, vapor deposition methods, and epitaxial methods. In some embodiments, the chosen fabrication method is based on the type of inorganic photosensitive layer deposited. For example, in some embodiments, an inorganic photosensitive layer comprising a-Si:H can be deposited using plasma enhanced chemical vapor deposition (PECVD) or hot wire chemical vapor deposition (HWCVD). Using PECVD or HWCVD to deposit an inorganic photosensitive layer comprising a-Si:H, in some embodiments, can permit the formation of a PIN structure of a-Si:H. In other embodiments, an inorganic photosensitive layer comprising CdTe can be deposited using PECVD. In some embodiments, an inorganic photosensitive layer comprising CZTS can be deposited using PECVD, HWCVD, or solution methods. In still other embodiments, depositing an inorganic photosensitive layer comprising CIGS can comprise depositing nanoparticles comprising CIGS. Nanoparticles can be deposited in any manner not inconsistent with the objectives of the present invention. In some embodiments, an inorganic photosensitive layer can be deposited by chemical vapor deposition (CVD), physical vapor deposition (PVD), molecular beam epitaxy (MBE), atomic layer epitaxy (ALE), solution atomic layer epitaxy (SALE) or pulsed laser deposition (PLD).

A second electrode is disposed in electrical communication with the at least one photosensitive layer. In some embodiments, disposing a second electrode in electrical communication with the at least one photosensitive layer comprises depositing the second electrode on the photosensitive organic layer through vapor deposition, spin coating or dip coating.

In another aspect, methods of converting electromagnetic energy into electrical energy are described herein. In some embodiments, a method of converting electromagnetic energy into electrical energy comprises receiving radiation at a side or circumferential area of a photovoltaic apparatus, the photovoltaic apparatus comprising a conduit core comprising at least one radiation transmissive surface, a fluid disposed in the conduit core, and a photoactive assembly at least partially surrounding the conduit core, the photoactive assembly comprising a radiation transmissive first electrode, at least one photosensitive layer electrically connected to the first electrode, and a second electrode electrically connected to the photosensitive layer. In some embodiments, radiation is received at a front side of a conduit core of a photovoltaic apparatus. In some embodiments, once the radiation is received at one or more points along the side or circumferential area of the photovoltaic apparatus, the radiation is transmitted into the at least one photosensitive layer of the photoactive assembly to generate excitons in the photosensitive layer. The generated holes and electrons are subsequently separated and the electrons removed into an external circuit in communication with the photovoltaic apparatus.

In some embodiments of methods of converting electromagnetic radiation into electrical energy, the path of at least a portion of the received electromagnetic radiation is altered by the fluid in the conduit core of the photovoltaic apparatus. In some embodiments, for example, at least a portion of the received radiation is refracted by the fluid in the conduit core. In some embodiments, at least a portion of the received radiation is focused or concentrated by the fluid in the conduit core onto the photosensitive layer. In some embodiments, the path altered radiation is transmitted into the at least one photosensitive layer of the photoactive assembly for the generation of excitons. Focusing or concentrating at least a portion of the received radiation, in some embodiments, can increase the total intensity of radiation or the intensity of radiation per area transmitted into the at least one photosensitive layer. Therefore, in some embodiments, fluid in the conduit core can serve to direct received electromagnetic radiation to the photoactive assembly at least partially surrounding the conduit core to provide greater amounts of electromagnetic radiation to the photoactive assembly, thereby increasing the performance of the photovoltaic device. Moreover, directing electromagnetic energy to the photoactive assembly with the fluid disposed in the conduit core, in some embodiments, permits the use of a photoactive assembly covering less surface area on the conduit core, thereby reducing production cost of the photovoltaic apparatus.

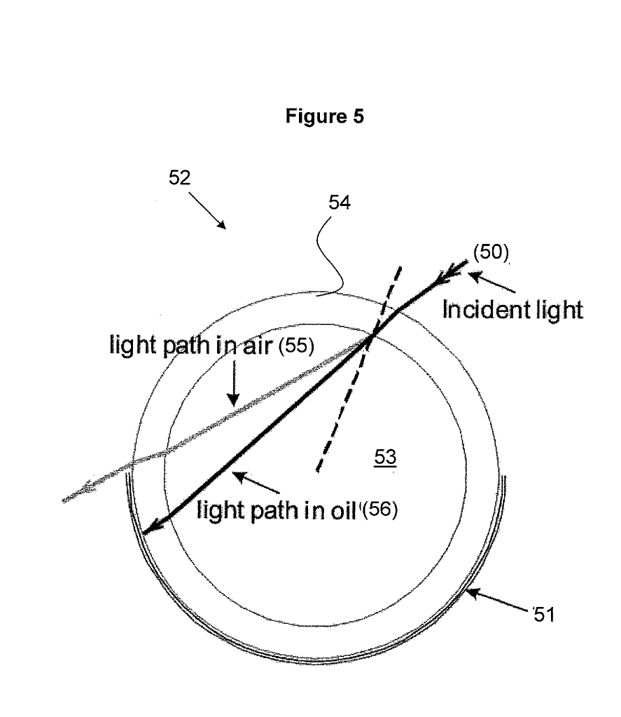

FIG. 5 illustrates altering the path of at least a portion of the radiation received by one embodiment of a photovoltaic apparatus described herein. As illustrated in FIG. 5, the incident light (50) has an optical path (55) in air missing the photosensitive layer (51) of the photovoltaic apparatus (52). However, when a fluid (53), such as oil, is disposed in the conduit core (54) of the photovoltaic apparatus (52), the path of the incident light (50) is altered by refraction. In the embodiment of FIG. 5, the path altered radiation (56) is transmitted into the photosensitive layer (51) of the photovoltaic apparatus.

In some embodiments, a method of converting electromagnetic radiation into electrical energy further comprises absorbing at least a portion of the received radiation with the fluid in the conduit core. In some embodiments, absorption of radiation by the fluid generates thermal energy. In one embodiment, for example, the fluid in the conduit core absorbs radiation having one or more wavelengths in the infrared region of the electromagnetic spectrum, the absorption of the radiation generating thermal energy. In some embodiments, the fluid is flowed through a heat exchanger or other apparatus operable to capture thermal energy generated in the fluid. Additionally, in some embodiments, the heat exchanged fluid is returned to the conduit core for further collection of thermal energy. The fluid can be flowed at any rate not inconsistent with the objectives of the present invention. In some embodiments, for example, the mass flow rate ranges from about 0.05 g/(s·cm) to about 5 g/(s·cm). In some embodiments, the mass flow rate ranges from about 0.05 g/(s·cm) to about 3 g/(s·cm), from about 0.05 g/(s·cm) to about 2 g/(s·cm), from about 0.05 g/(s·cm) to about 1.5 g/(s·cm), from about 0.2 g/(s·cm) to about 1.2 g/(s·cm), or from about 0.3 g/(s·cm) to about 1 g/(s·cm). In some embodiments, the flow rate is chosen to maximize the solar-thermal efficiency.

These and other embodiments can be further understood with reference to the following non-limiting example.

### Example 1

### Photovoltaic Apparatus

A photovoltaic device described herein was constructed as follows. A glass tube conduit core having an inner diameter of 1.5 mm, an outer diameter of 1.8 mm, and one end closed in a hemispherical cap was obtained from Chemglass, Inc., of Vineland, N.J. The glass tube was cleaned in an ultrasonic bath and dried. A radiation transmissive first electrode of ITO having a thickness of 100 nm was deposited on about 50 percent of the exterior surface of the glass tube by radio frequency (rf) magnetron sputtering from an ITO target at 80° C., forming an approximately semi-cylindrical first electrode on the tube surface. The tube was subsequently exposed to ozone for 90 minutes. An organic photosensitive layer was then deposited on the radiation transmissive ITO first electrode by a dip coating procedure. The organic photosensitive layer included poly(3,4-ethylenedioxythiophene)-poly(styrenesulfonate) (PEDOT:PSS, Clevios, thickness ˜200 nm) and P3HT:PCBM (1:0.8 by wt, 12 mg/mL solution in chlorobenzene, thickness ˜150 nm). An aluminum second electrode was deposited over the organic photosensitive layer via thermal evaporation at a pressure of 10⁻⁶ torr. The length of the tube with active area was 1.8 cm. A silicone oil having a specific heat capacity of 2.49 kJ/(kg ° C.) was disposed as a fluid in the conduit core. Various properties of the fabricated photovoltaic device comprising silicone oil disposed in the conduit core were determined. As a control, properties were also determined with air rather than silicone oil disposed in the conduit core of the device.

The properties of the photovoltaic device were tested using an AM 1.5 g standard Newport #96000 Solar Simulator with an illumination intensity of 100 mW/cm². The device was illuminated as illustrated in FIG. 1 herein. Current voltage characteristics were collected using a Keithley 236 source-measurement unit. External quantum efficiencies (EQE) were measured using a Newport Cornerstone 260 Monochromator in conjunction with a Newport 300 W Xenon light source. Photothermal characteristics were measured using a K-type thermocouple probe and a stopwatch. When present, the temperature of the silicone oil inside the tube was measured using the K-type thermocouple, which was immersed in the silicone oil. Heating and/or illumination times were measured with the stopwatch. The angle of incidence of the illumination was varied by rotating the tube around its central axis and using a stationary light source.

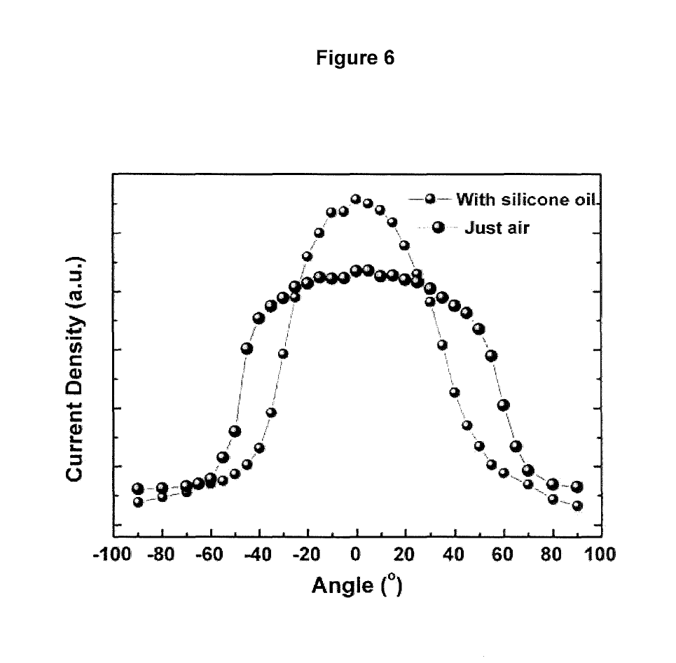

The angle-dependent performance of the device comprising silicone oil in the conduit core was compared with the performance of the device comprising only air in the conduit core. FIG. 6 shows the current density of the device as a function of illumination angle, where zero degrees represents illumination normal to the center of the semi-cylinder of the photovoltaic on the back of the tube. The presence of silicone oil in the conduit core resulted in an enhancement in the current density of up to about 30 percent across an angular span of about 50 degrees.

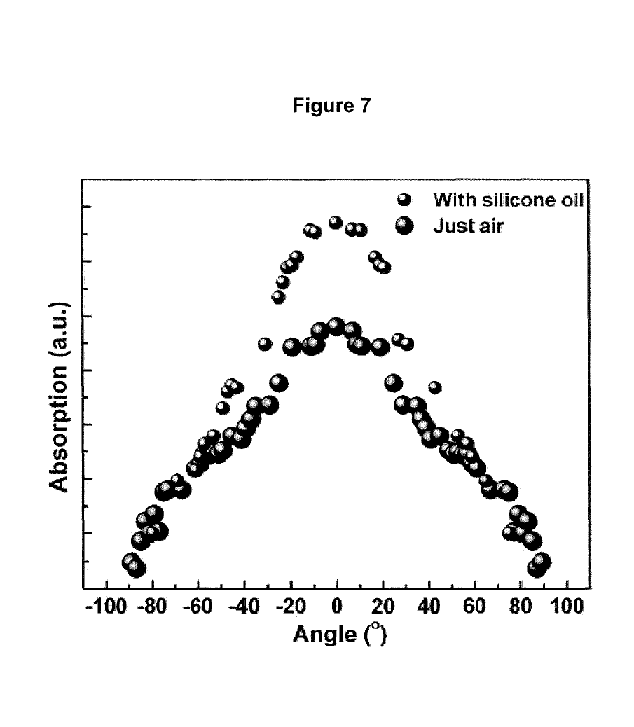

Moreover, a calculation of the angle-dependent absorption of the device demonstrated an absorbance enhancement as well. The calculation was based on optical path models of reflection and refraction in tubes, as described, for example, in Li, Y.; Zhou, W.; Xue, D.; Liu, J. W.; Peterson, E. D.; Nie, W. Y.; Carroll, D. L., “Origins of performance in fiber-based organic photovoltaics,” Applied Physics Letters, 2009, 95; Pettersson, L. A. A.; Roman, L. S.; Inganas, O.; “Modeling photocurrent action spectra of photovoltaic devices based on organic thin films,” Journal of Applied Physics, 1999, 86, 487-496; and Sievers, D. W.; Shrotriya, V.; Yang, Y., “Modeling optical effects and thickness dependent current in polymer bulk-heterojunction solar cells,” Journal of Applied Physics, 2006, 100, the entireties of which are hereby incorporated by reference. Briefly, ray tracing methods were used with the Fresnel equations to calculate where light would occur in reflection and refraction, along with the corresponding angle and intensity. A transfer matrix was then used to simulate the optical field distribution and account for interference in a thin film. The incident angle dependence was simulated in the software package OPVAP (www.OPVAP.inwake.com). FIG. 7 illustrates the absorbance enhancement provided to the photovoltaic device by the presence of silicone oil in the conduit core.

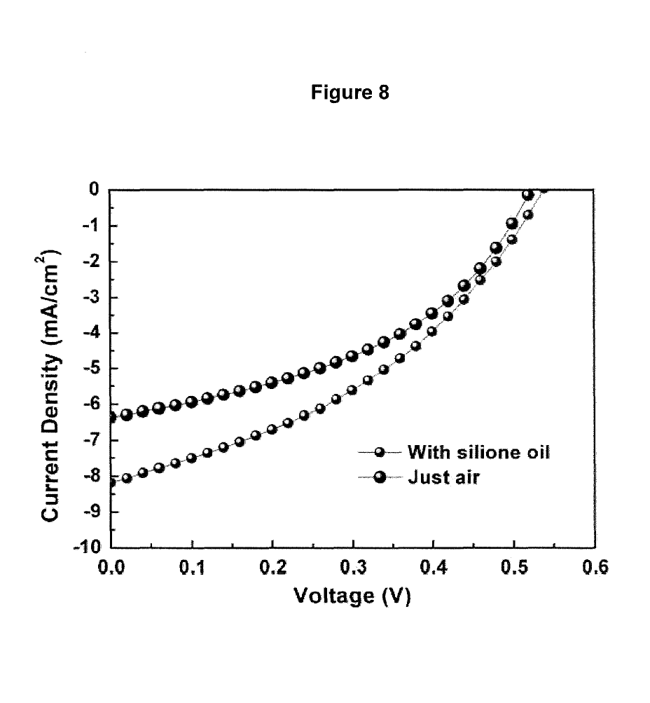

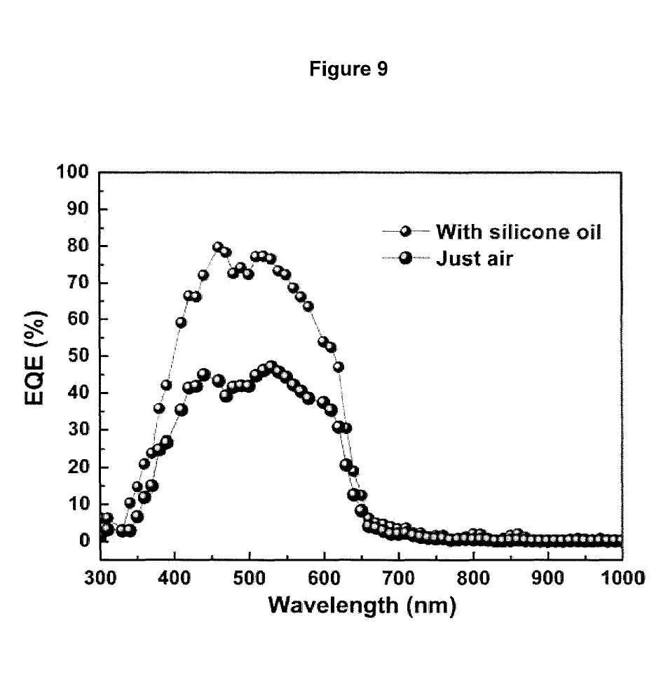

In addition to angle-dependent measurements, photovoltaic device characteristics were also compared at zero degrees illumination. Current density-voltage results are provided in FIG. 8, and external quantum efficiency (EQE) results are provided in FIG. 9. As provided in FIGS. 8 and 9, the performance of the photovoltaic apparatus was significantly enhanced by the presence of silicone oil rather than air in the conduit core.

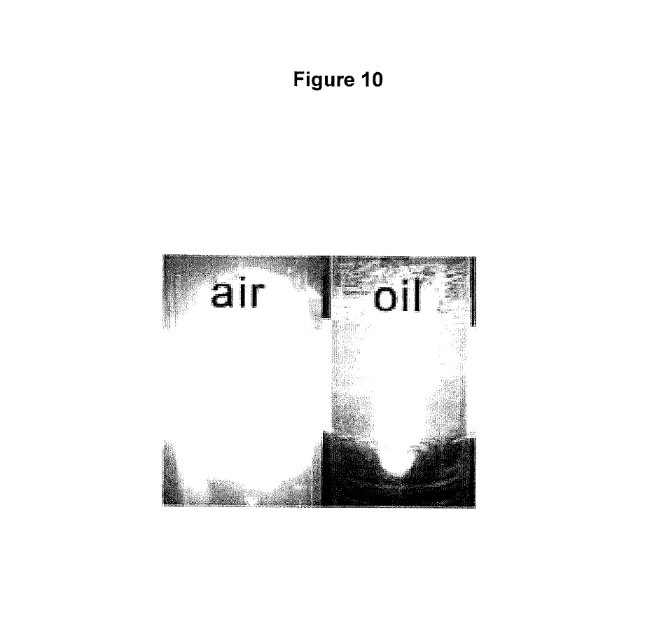

Optical experiments regarding light distribution in the tube in the presence of silicone oil and air were also conducted. Devices similar to the device of the present example were constructed, except neither the organic photosensitive layer nor the second electrode was added. The devices (containing either silicone oil or air in the conduit core) were then illuminated with the solar simulator from one side and inspected visually. FIG. 10 illustrates that the presence of silicone oil in the conduit core focuses the solar simulator beam.

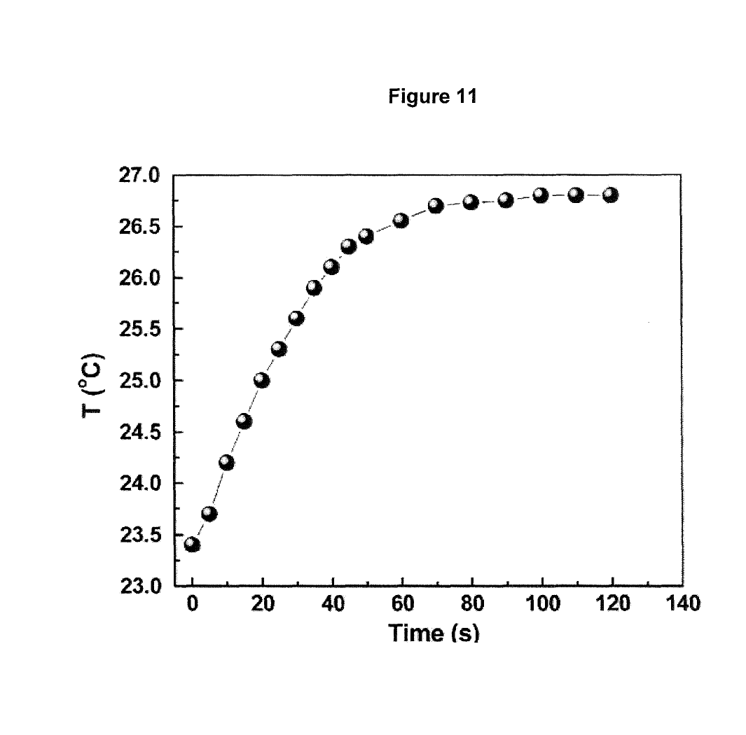

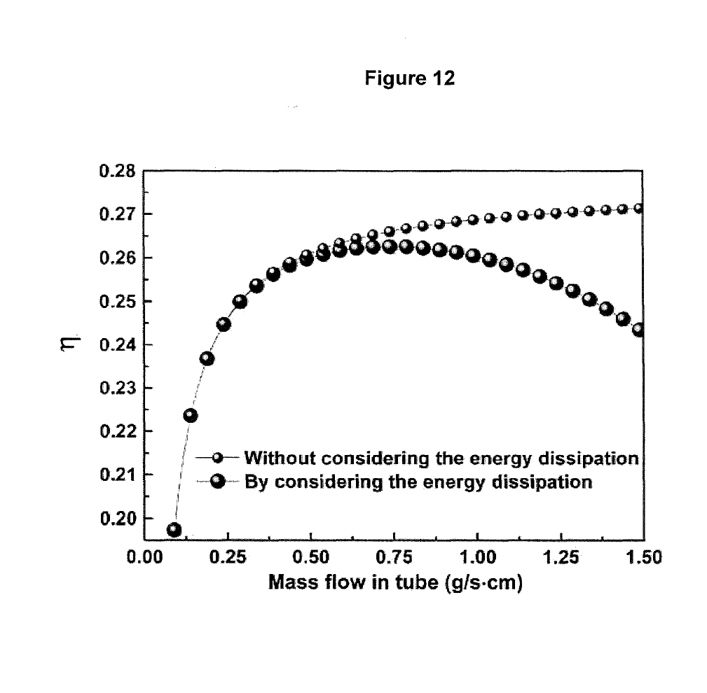

Furthermore, FIGS. 11 and 12 illustrate the thermal properties of the photovoltaic device comprising silicone oil disposed in the conduit core. The K-type thermocouple was placed in the conduit core outside of the illuminated area, and the temperature of the silicone oil in the conduit core was measured under static conditions (i.e., without agitating or flowing the oil) as a function of illumination time. FIG. 11 illustrates the accumulated temperature increase of the silicone oil. Shunting the silicone oil into a heat exchanger as described herein permits the production of thermal energy in addition to electrical energy. FIG. 12 illustrates the calculated solar-thermal efficiency of the device of the present example as a function of mass flow rate in the tube, with and without considering the mechanical energy loss of the flowing liquid.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

That which is claimed is:

1. An apparatus comprising:
a conduit core comprising at least one radiation transmissive surface;
a fluid disposed in the conduit core; and
a photoactive assembly at least partially surrounding the conduit core, the photoactive assembly comprising a radiation transmissive first electrode, at least one photosensitive layer electrically connected to the first electrode, and a second electrode electrically connected to the photosensitive layer.

2. The apparatus of claim 1, wherein the at least one photosensitive layer comprises a photosensitive organic composition.

3. The apparatus of claim 1, wherein the at least one photosensitive layer comprises a photosensitive inorganic composition.

4. The apparatus of claim 1, wherein the photoactive assembly surrounds up to about 50 percent of the exterior of the conduit core.

5. The apparatus of claim 1, wherein at least one photosensitive layer surrounds more than about 50 percent of the exterior of the conduit core.

6. The apparatus of claim 1, wherein the fluid is operable to alter the path of at least a portion of electromagnetic radiation received by the apparatus.

7. The apparatus of claim 6, wherein the fluid is operable to focus the portion of electromagnetic radiation on the photoactive assembly at least partially surrounding the conduit core.

8. The apparatus of claim 6, wherein the fluid has an index of refraction different from the index of refraction of the conduit core.

9. The apparatus of claim 1 further comprising at least one Stokes shift material disposed in the fluid.

10. The apparatus of claim 9, wherein the Stokes shift material is operable to absorb radiation in the near ultraviolet region of the electromagnetic spectrum.

11. The apparatus of claim 9, wherein the Stokes shift material has an emission profile that at least partially overlaps with the absorption profile of a photosensitive layer of the photoactive assembly.

12. The apparatus of claim 1, wherein the fluid is operable to absorb radiation having one or more wavelengths falling within at least one of the infrared, visible and ultraviolet regions of the electromagnetic spectrum.

13. The apparatus of claim 12, wherein the fluid comprises a thermal fluid.

14. The apparatus of claim 1, wherein the apparatus is coupled to a heat exchange apparatus.

15. The apparatus of claim 14, wherein the apparatus has a solar-thermal efficiency of at least about 15 percent.

16. A photovoltaic apparatus comprising:
at least one photovoltaic cell, the photovoltaic cell comprising a conduit core comprising at least one radiation transmissive surface, a fluid disposed in the conduit core, and a photoactive assembly at least partially surrounding the conduit core, the photoactive assembly comprising a radiation transmissive first electrode, at least one photosensitive layer electrically connected to the first electrode, and a second electrode electrically connected to the photosensitive layer.

17. The photovoltaic apparatus of claim 16 further comprising at least one Stokes shift material disposed in the fluid.

18. The photovoltaic apparatus of claim 16 comprising a plurality of the photovoltaic cells.

19. The photovoltaic apparatus of claim 18, wherein the plurality of photovoltaic cells are coupled to a heat exchange apparatus.

20. The photovoltaic apparatus of claim 19, wherein the apparatus has a solar-thermal efficiency of at least about 15 percent.

21. The photovoltaic apparatus of claim 16, wherein the fluid is in thermal contact with a thermoelectric apparatus.

22. A method comprising:
receiving radiation at a side or circumferential area of a photovoltaic apparatus, the photovoltaic apparatus comprising a conduit core comprising at least one radiation transmissive surface, a fluid disposed in the conduit core, and a photoactive assembly at least partially surrounding the conduit core, the photoactive assembly comprising a radiation transmissive first electrode, at least one photosensitive layer electrically connected to the first electrode and a second electrode electrically connected to the photosensitive layer;
altering the path of at least a portion of the received radiation with the fluid;
transmitting at least a portion of the path altered radiation into the photosensitive layer to generate excitons in the photosensitive layer.

23. The method of claim 22, wherein altering the path of at least a portion of the received radiation with the fluid comprises directing the portion of received electromagnetic radiation to the photoactive assembly at least partially surrounding the conduit core.

24. The method of claim 23, wherein the fluid serves to increase the amount of electromagnetic radiation provided to the photoactive assembly.

25. The method of claim 22 further comprising separating holes and electrons of the excitons.

26. The method of claim 25 further comprising removing the electrons into an external circuit.

27. The method of claim 22 further comprising absorbing at least a portion of the received radiation with the fluid to generate thermal energy in the fluid.

28. The method of claim 27 further comprising flowing the fluid through a heat exchange apparatus.

29. The method of claim 28 further comprising returning the fluid to the conduit core of the photovoltaic apparatus for the generation of additional thermal energy.

30. A method of making a photovoltaic apparatus comprising:
providing a conduit core comprising at least one radiation transmissive surface;
disposing a fluid in the conduit core; and
at least partially surrounding the conduit with a photoactive assembly, the photoactive assembly comprising a radiation transmissive first electrode, at least one photosensitive layer electrically connected to the first electrode, and a second electrode electrically connected to the photosensitive layer.

31. The method of claim 30, wherein the photoactive assembly is fabricated on the conduit core.
